(19) United States
(12) Patent Application Publication
(10) Pub. No.: US 2024/0216877 A1
(43) Pub. Date: Jul. 4, 2024

(54) ULTRAFINE BUBBLE-CONTAINING LIQUID PRODUCING APPARATUS AND METHOD

(71) Applicant: CANON KABUSHIKI KAISHA, Tokyo (JP)

(72) Inventor: AKIRA YAMAMOTO, Kanagawa (JP)

(21) Appl. No.: 18/391,097

(22) Filed: Dec. 20, 2023

(30) Foreign Application Priority Data
Dec. 28, 2022 (JP) 2022-212045

(51) Int. Cl. B01F 23/2375; B01F 23/232; B01F 35/221; B01F 35/93

(52) U.S. Cl. CPC B01F 23/2375; B01F 23/2323; B01F 35/2216; B01F 35/93

(57) ABSTRACT

An ultrafine bubble-containing liquid producing apparatus and method enables preventing ultrafine bubbles over a long period of operation by, based on a predetermined condition, switching between a first mode where a liquid between an ultrafine bubble generating unit and a storing chamber is circulated at a first flow velocity and a second mode where the liquid is circulated at a second flow velocity higher than the first flow velocity.

### BACKGROUND

### Field

The present disclosure relates to an ultrafine bubble-containing liquid producing apparatus and method.

### Description of the Related Art

In recent years, techniques have been developed which use characteristics of fine bubbles such as microbubbles measuring 1 to 100 μm in diameter and ultrafine bubbles (hereinafter referred to also as “UFBs”) measuring less than 1.0 μm in diameter.

Japanese Patent Laid-Open No. 2015-181976 discloses an apparatus in which a pressurized dissolution unit that pressurizes a desired gas to dissolve it into a liquid, and a fine bubble generation unit that ejects the liquid from a minute nozzle to generate fine bubbles are provided in the same liquid circulation path to generate fine bubbles at high density.

Also, Japanese Patent Laid-Open No. 2019-42732 discloses a method in which film boiling is caused in a liquid with heating resistance elements to generate UFBs measuring less than 1.0 μm in diameter, and discloses an apparatus in which a circulating mechanism is provided to efficiently generate a liquid containing UFBs at high density.

Here, in a case where a UFB producing apparatus operates for a long period of time, the temperature of its UFB generating unit rises. As a result, the temperature of the liquid rises. This leads to a possibility of lowering the degree of dissolution of the gas and decreasing the amount of the gas dissolved in the liquid, thereby decreasing the UFB generation efficiency.

### SUMMARY

In view of the above, the present disclosure provides a UFB-containing liquid producing apparatus and method capable of preventing a decrease in UFB generation efficiency in a long period of operation.

An ultrafine bubble-containing liquid producing apparatus includes an ultrafine bubble generating unit configured to generate ultrafine bubbles inside a liquid, a circulating unit configured to circulate the liquid through a circulation path including the ultrafine bubble generating unit, and a control unit configured to control the ultrafine bubble generating unit and the circulating unit, wherein the control unit, based on a predetermined condition, switches between a first mode where the liquid in the circulation path is circulated at a first flow velocity and a second mode where the liquid in the circulation path is circulated at a second flow velocity higher than the first flow velocity.

Further features of the present disclosure will become apparent from the following description of exemplary embodiments with reference to the attached drawings.

### BRIEF DESCRIPTION OF THE DRAWINGS

FIG. 1 is a schematic configuration diagram illustrating an ultrafine bubble-containing liquid producing apparatus;

FIG. 2 is a perspective view illustrating a UFB generating unit;

FIG. 3 is an exploded perspective view of a heating element substrate;

FIG. 4 is a block diagram illustrating a control configuration in the UFB-containing liquid producing apparatus;

FIG. 5 is a flowchart illustrating a process of generating a UFB-containing liquid;

FIG. 6 is a flowchart illustrating processes in a UFB generating step;

FIG. 7 is a flowchart illustrating processes in a UFB generating step;

FIG. 8A is a graph illustrating a temperature rise profile obtained by actually measuring the temperature of the UFB generating unit;

FIG. 8B is a graph illustrating a temperature rise profile obtained by actually measuring the temperature of the UFB generating unit;

FIG. 9A is a flowchart illustrating processes in a UFB generating step;

FIG. 9B is a flowchart illustrating processes in the UFB generating step; and

FIG. 9C is a flowchart illustrating processes in the UFB generating step.

### DESCRIPTION OF THE EMBODIMENTS

A first embodiment of the present disclosure will be described below with reference to drawings.

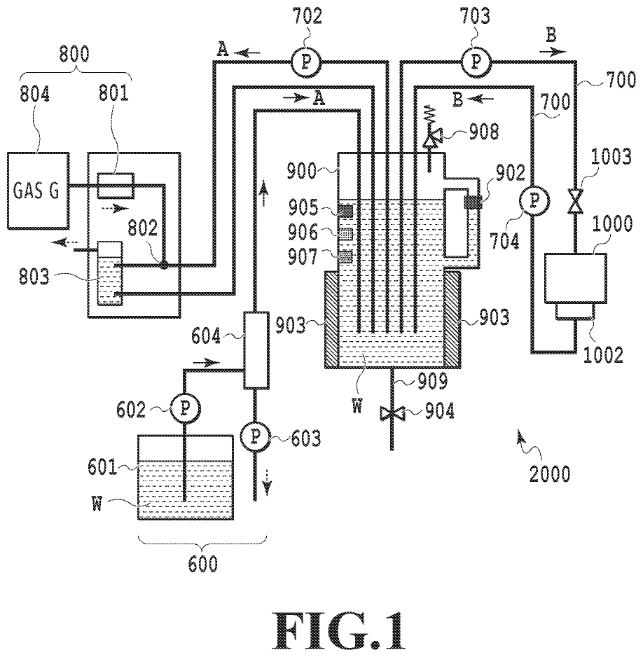

FIG. 1 is a schematic configuration diagram illustrating an ultrafine bubble-containing liquid producing apparatus 2000 (hereinafter referred to as “UFB-containing liquid producing apparatus 2000”) to which the present embodiment is applicable. The UFB-containing liquid producing apparatus 2000 includes a liquid supplying unit 600, a gas dissolving unit 800, a storing chamber 900, and an ultrafine bubble generating unit 1000 (hereinafter referred to as “UFB generating unit 1000”). In FIG. 1, each solid arrow represents a liquid flow, and each dotted arrow represents a gas flow.

The liquid supplying unit 600 includes a liquid reservoir unit 601, two pumps 602 and 603, and a degassing unit 604. A liquid W contained in the liquid reservoir unit 601 is transferred to the storing chamber 900, which is capable of storing the liquid, by the pump 602 via the degassing unit 604. Inside the degassing unit 604 is disposed a film through which only gases can pass. With the pump 603 actuated, the inside of the degassing unit 604 is depressurized, and only gases pass through the film, so that the gases and the liquid are separated from each other.

The liquid W is moved toward the storing chamber 900 whereas the gases are discharged to the outside. Various gases may be dissolved in the liquid contained in the liquid reservoir unit 601. Removing the dissolved gases at the degassing unit 604 before transferring the liquid to the storing chamber 900 enhances the efficiency of dissolution in a subsequent gas dissolving step.

The gas dissolving unit 800 includes a gas supplying unit 804, a pre-processing unit 801, a merging part 802, and a gas-liquid separating chamber 803. While the gas supplying unit 804 may be a gas cylinder storing a desired gas G, the gas supplying unit 804 may be an apparatus capable of continuously generating the desired gas G. For example, in a case where the desired gas G is oxygen, it is possible to employ an apparatus that takes in the atmospheric air, removes nitrogen, and feeds the gas from which nitrogen has been removed with a pump.

The gas G supplied by the gas supplying unit 804 is subjected to a process such as electrical discharging at the pre-processing unit 801. Then, at the merging part 802, the gas G merges with the liquid W having flowed out of the storing chamber 900. At this time, part of the gas G gets dissolved into the liquid W. The gas G and the liquid W having thus merged are separated from each other again at the gas-liquid separating chamber 803, and only the part of the gas G that has not been dissolved into the liquid W is discharged to the outside. The liquid W with the gas G dissolved therein is then transferred to the UFB generating unit 1000 by a pump 703.

The storing chamber 900 stores a mixed liquid of the liquid W supplied from the liquid supplying unit 600, the liquid W in which the desired gas G has been dissolved by the gas dissolving unit 800, and the UFB-containing liquid generated by the UFB generating unit 1000. A temperature sensor 905 detects the temperature of the liquid stored in the storing chamber 900. A liquid surface sensor 902 is disposed at a predetermined height in the storing chamber 900 and detects the surface of the liquid W. A UFB density sensor (density detecting unit) 906 detects the UFB density of the liquid W stored in the storing chamber 900. A dissolution degree sensor 907 detects the degree of dissolution of gases in the liquid W stored in the storing chamber 900. A valve 904 is opened in a case of discharging the liquid W stored in the storing chamber 900 to a container on the outside through a collection path 909. Though not illustrated in FIG. 1, the storing chamber 900 can be provided with an agitating unit therein for making the temperature of and the UFB distribution in the liquid W uniform.

A cooling unit 903 is capable of controlling the temperature of the liquid W stored in the storing chamber 900, and is capable of cooling the liquid W that has become hot. It is preferable that the temperature of the liquid W to be supplied to the gas dissolving unit 800 be as low as possible in order to efficiently dissolve the desired gas G at the gas dissolving unit 800. In the present embodiment, the temperature of the liquid W to be supplied to the gas dissolving unit 800 is adjusted at 10° C. or lower by using the cooling unit 903 while the temperature of the liquid W is detected with the temperature sensor 905. The configuration of the cooling unit 903 is not particularly limited. For example, it is possible to employ a type which uses a Peltier device or a type which circulates a liquid cooled by a chiller. In the case of the latter, a cooling tube through which a cooling liquid is circulated can be wound around the outer periphery of the storing chamber 900 as illustrated in FIG. 1, or the storing chamber 900 can be formed to have a hollow structure with a cooling tube disposed in the hollow space. Alternatively, the configuration can be such that a cooling tube is immersed in the liquid W inside the storing chamber 900.

A valve 1003 (closing unit) is provided upstream of the UFB generating unit 1000, and a pump 704 is provided downstream of the UFB generating unit 1000.

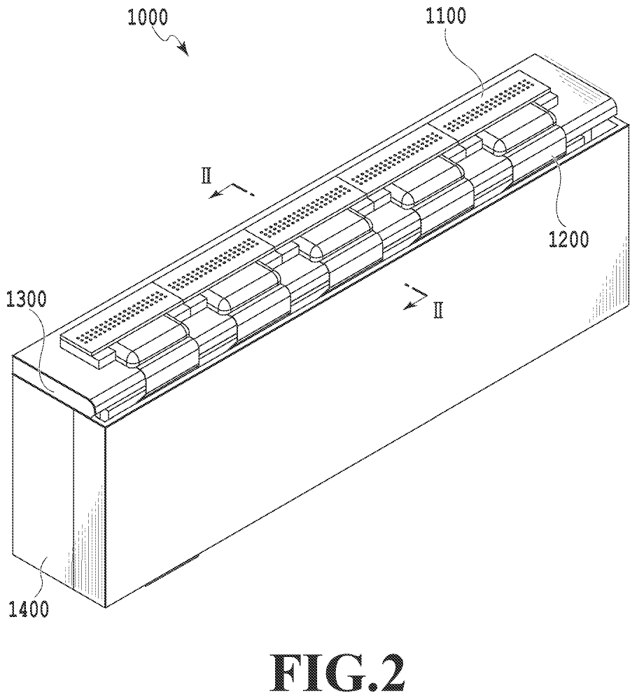

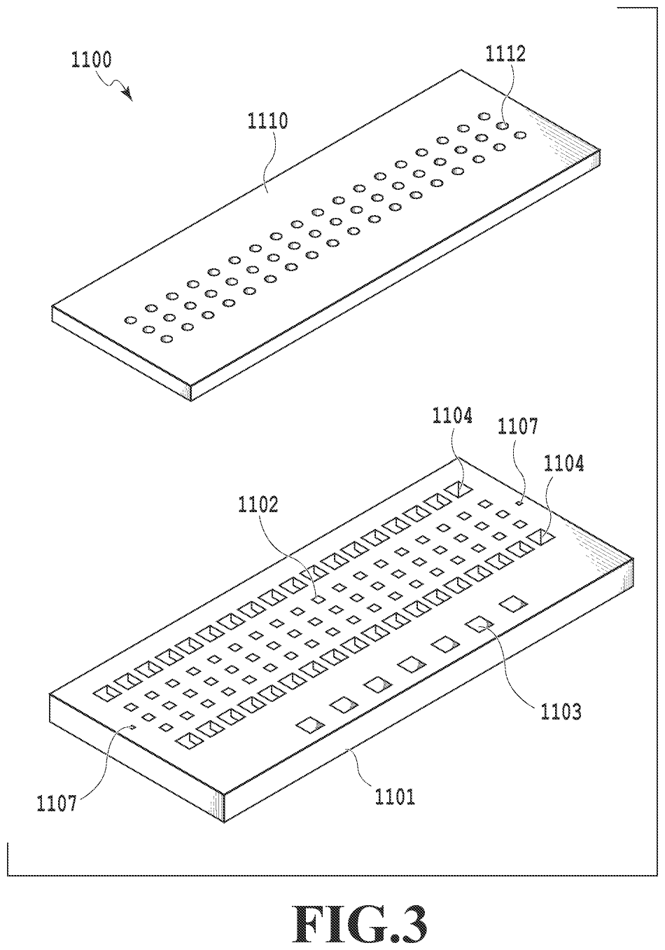

FIG. 2 is a perspective view illustrating the UFB generating unit 1000. FIG. 3 is an exploded perspective view of a heating element substrate 1100. The UFB generating unit 1000 generates UFBs in the liquid W caused to flow into the UFB generating unit 1000. In the present embodiment, a thermal-ultrafine bubble (hereinafter referred to also as “T-UFB”) method that causes film boiling at the interfaces between heating elements 1102 and the liquid is used as the method of generating UFBs. The UFB generating unit 1000 includes a plurality of the heating element substrates 1100. Each heating element substrate 1100 includes a Si substrate 1101 and an ejection port plate 1110. Multiple ejection ports 1112 are disposed in the ejection port plate 1110, and multiple heating elements 1102 are disposed on the Si substrate 1101. The multiple heating element substrates 1100 are supported and arrayed on a support member 1300 attached to a UFB generating unit housing 1400. Terminals 1103 for connecting to flexible wirings 1200 are disposed on the Si substrate 1101. The heating elements 1102 are supplied with electric power through the flexible wirings 1200 and the terminals 1103. The heating elements 1102 generate heat as voltage pulses applied to them. The liquid is supplied from supply paths 1104 to the heating elements 1102, which are caused to generate heat to eject droplets containing UFBs from the ejection ports 1112. Temperature sensors (temperature detecting unit) 1107 are formed at regions of the heating element substrate 1100 where the heating elements 1102 are not disposed, and read the temperature of the heating element substrate 1100.

As illustrated in FIG. 1, the liquid supplying unit 600, the gas dissolving unit 800, the storing chamber 900, and the UFB generating unit 1000 are connected by pipes 700 and form a path through which the liquid W is circulated with a pump 702, the supply pump 703, and the collection pump 704. FIG. 1 illustrates a case where a circulation path A for dissolving the gas and a circulation path B for generating a UFB-containing liquid are formed. In this case, the circulation paths A and B are each capable of circulation under any conditions.

In the circulation path B, the liquid W can be circulated with or without the UFB generating unit 1000 driven. In a case where the UFB generating unit 1000 is not driven, the liquid supplied from the supply paths 1104, flowing over the surfaces of the heating elements 1102, and passing through the ejection ports 1112 is circulated. In a case where the UFB generating unit 1000 is driven, the liquid supplied from the supply paths 1104 and ejected from the ejection ports 1112 by driving the heating elements 1102 is circulated. The flow velocity in the circulation path B may be determined based on the total amount of droplets to be ejected from the ejection ports 1112 in the UFB generating unit 1000 or the like.

FIG. 1 illustrates a configuration provided with the circulation path A including the gas dissolving unit 800 at an intermediate portion of the circulation path for dissolving the gas. Alternatively, a configuration in which the gas G is supplied directly to the storing chamber 900 can be employed. In this way, a smaller UFB-containing liquid producing apparatus can be implemented.

The positions of the pumps and the number of pumps are not limited to those illustrated in FIG. 1. Moreover, each component's configuration can be provided with a pump and/or a valve that may be necessary to drive the component. A pump whose pulsation and flow rate variation are small is preferably used to avoid impairing the UFB generation efficiency. Also, the collection path 909 and the valve 904 for collecting the liquid W can be provided not at the storing chamber 900 but at another position in either liquid circulation path. The temperature sensor 905, the UFB density sensor 906, and the dissolution degree sensor 907 do not necessarily have to be provided at the positions illustrated in FIG. 1. These sensors can be provided at other positions as long as they are within the circulation paths. Alternatively, the configuration can be such that each sensor is provided at a plurality of positions in the circulation paths and an average value can be outputted.

Members that contact the UFB-containing liquid such as the pipes 700, the pump 702, the supply pump 703, the collection pump 704, the valve 1003, the storing chamber 900, and the UFB generating unit 1000 are preferably made of a material with high corrosion resistance. For example, a fluorine-based resin such as polytetrafluoroethylene (PTFE) or perfluoroalkoxy alkane (PFA), a metal such as SUS316L, or another inorganic material can be preferably used. In this way, it is possible to generate UFBs in a suitable manner even in a case of using a highly corrosive gas G and liquid W.

In the present embodiment, the configuration is such that the liquid W is circulated between the UFB generating unit 1000 and the storing chamber 900 through the circulation path B. Here, in the UFB generating unit 1000, the circulation includes a step of ejecting droplets from the ejection ports and collecting the droplets with a collecting member 1002. Thus, the circulation path includes a portion where the liquid W flies through a gap in the form of droplets.

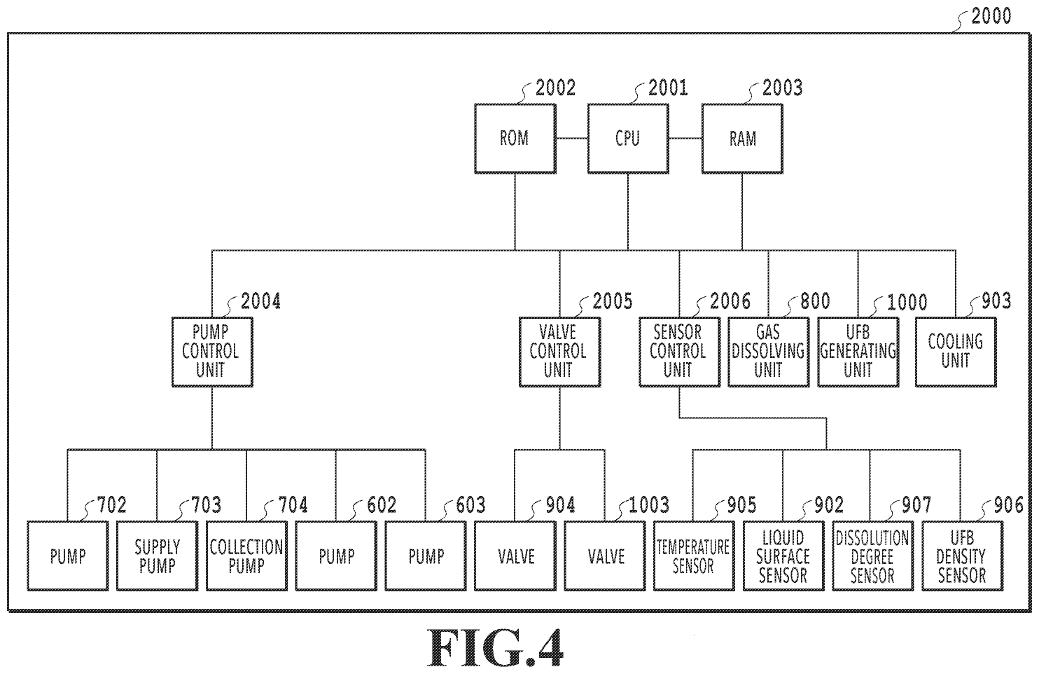

FIG. 4 is a block diagram illustrating a control configuration in the UFB-containing liquid producing apparatus 2000 in the present embodiment. A central processing unit (CPU) 2001 controls the entire apparatus while using a random-access memory (RAM) 2003 as a work area based on a program stored in a rear-only memory (ROM) 2002. Under the instruction of the CPU 2001, a pump control unit 2004 controls the driving of various pumps provided in the circulation paths illustrated in FIG. 1, including the pumps 602, 603, 702, 703, and 704. A valve control unit 2005 is configured to be capable of controlling the opening and closing of various valves including the valves 904 and 1003 under the instruction of the CPU 2001. Under the instruction of the CPU 2001, a sensor control unit 2006 controls various sensors including the dissolution degree sensor 907, the liquid surface sensor 902, the temperature sensor 905, and the UFB density sensor 906 and provides the detection values of the various sensors to the CPU 2001.

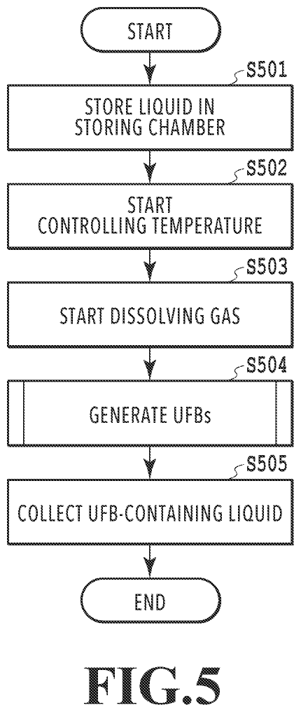

FIG. 5 is a flowchart illustrating a process of generating a UFB-containing liquid by the UFB-containing liquid producing apparatus 2000 in the present embodiment. The CPU 2001 of the UFB-containing liquid producing apparatus 2000 performs the series of processes illustrated in FIG. 5 by loading program code stored in the ROM 2002 to the RAM 2003 and executing it. Alternatively, the functions of some or all of the steps in FIG. 5 can be implemented with hardware such as an application-specific integrated circuit (ASIC) or an electronic circuit. The symbol “S” in the description of each process means a step in the flowchart.

Upon start of the process of generating a UFB-containing liquid, the CPU 2001 stores a predetermined amount of the liquid in the storing chamber 900 in S501.

Specifically, the CPU 2001 drives the pumps 602 and 603 while monitoring the detection by the liquid surface sensor 902. Thus, the liquid W stored in the liquid supplying unit 600 is degassed at the degassing unit 604 and transferred to the storing chamber 900. Then, in a case where the liquid surface sensor 902 detects the liquid surface, the CPU 2001 stops driving the pumps 602 and 603. As a result, the predetermined amount of the liquid W is stored in the storing chamber 900. Then, in S502, the CPU 2001 starts controlling the temperature of the liquid W stored in the storing chamber 900. Specifically, the CPU 2001 drives the cooling unit 903 while monitoring the temperature detected by the temperature sensor 905. Then, in S503, the CPU 2001 starts dissolving the gas when the temperature detected by the temperature sensor 905 reaches 10° C. or lower. Specifically, the CPU 2001 drives the gas dissolving unit 800 and the pump 702 to start circulating the liquid W in the circulation path A.

In S504, the CPU 2001 performs UFB generation in response to the dissolution degree sensor 907 detecting a predetermined degree of dissolution. Details of the UFB generation will be described below. Incidentally, the temperature of the liquid W and the degree of dissolution of the gas are continuously controlled during the UFB generation. Specifically, the CPU 2001 starts and stops driving the above components while monitoring the temperature sensor 905 and the dissolution degree sensor 907 such that the temperature of the liquid W and the degree of dissolution of the gas stay within respective predetermined ranges. Then, in S505, the CPU 2001 finishes all of the driving operations and opens the valve 904 to collect the UFB-containing liquid. The process then ends.

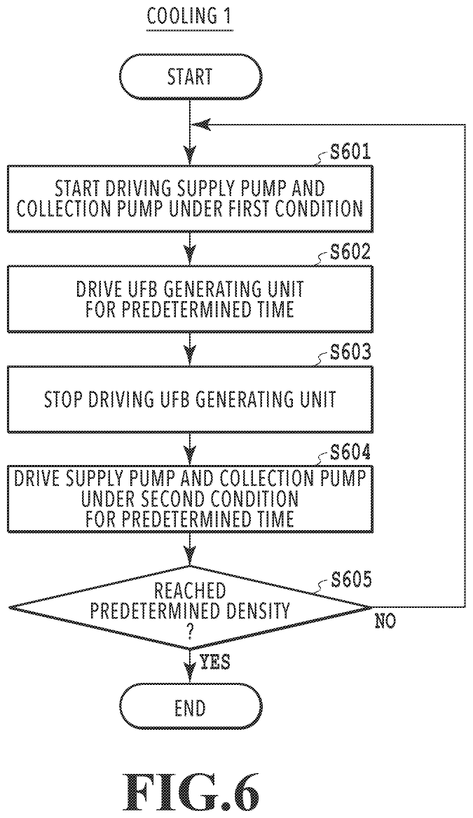

FIG. 6 is a flowchart illustrating the processes in the UFB generating step (S504) in the process of generating a UFB-containing liquid illustrated in FIG. 5. Details of a case of continuously generating UFBs for a long period in the UFB generating step will be described below using the flowchart of FIG. 6.

Upon start of the UFB generating step, in S601, the CPU 2001 drives the supply pump 703 and the collection pump 704 under a first condition to circulate the liquid W through the circulation path B. Then, in S602, the CPU 2001 drives the UFB generating unit 1000 for a predetermined time. The driving time is determined as appropriate according to the driving frequency of the heating elements 1102. A table in which driving frequencies and driving times are associated with each other is stored in the ROM in advance. Thereafter, the CPU 2001 stops the UFB generating unit 1000 in S603 and drives the supply pump 703 and the collection pump 704 under a second condition for a predetermined time in S604. Here, the flow velocity is higher in the second condition than in the first condition.

By circulating the liquid W faster than under the first condition, the amount of the liquid passing through the UFB generating unit 1000 increases, thereby cooling down the UFB generating unit 1000. This suppresses a rise in the temperature of the liquid W at the UFB generating unit and thus prevents a decrease in the amount of the gases dissolved in the liquid. In the present embodiment, the first condition (first mode) is 30 mL/min, and the second condition (second mode) is 300 mL/min. The second condition is desirably set with the amount of heat to be generated by the heating elements 1102 and the cooling performance of the cooling unit 903 taken into account.

In S605, the CPU 2001 determines whether the density of UFBs in the UFB-containing liquid inside the storing chamber 900 has reached a predetermined density based on the detection value of the UFB density sensor 906, and returns to S601 and repeats the processes if the density has not reached the predetermined density. The CPU 2001 terminates the process if the density has reached the predetermined density.

In the present embodiment, the supply pump 703 and the collection pump 704 are driven under the second condition for a predetermined time after the UFB generating unit 1000 is stopped (S603), as described above. However, the present embodiment is not limited to this case. The supply pump 703 and the collection pump 704 may be driven under the second condition for a predetermined time while the UFB generating unit 1000 is kept driven.

The present embodiment has been described using an UFB producing apparatus employing the T-UFB method, but the UFB generating method is not limited to this method. The present embodiment is also applicable to cases where other methods are used. Moreover, the present embodiment is applicable to not only apparatuses for producing UFBs measuring less than 1 μm, but also to apparatuses for producing microbubbles measuring 1 to 100 μm.

As described above, the operation is switched between the first mode, in which the liquid between the ultrafine bubble generating unit 1000 and the storing chamber 900 is circulated at a first flow velocity, and the second mode, in which the liquid is circulated at a second flow velocity higher than the first flow velocity, based on a predetermined condition. In this way, it is possible to provide a UFB-containing liquid producing apparatus and method capable of preventing a decrease in UFB generation efficiency in a long period of operation.

A second embodiment of the present disclosure will be described below with reference to drawings. Note that the basic configuration in the present embodiment is similar to that in the first embodiment, and the characteristic configuration will therefore be described below. In the present embodiment, the condition for the supply pump 703 and the collection pump 704 is switched and the driving of the UFB generating unit 1000 is controlled based on the temperature detected by the temperature sensors 1107 on the heating element substrate 1100.

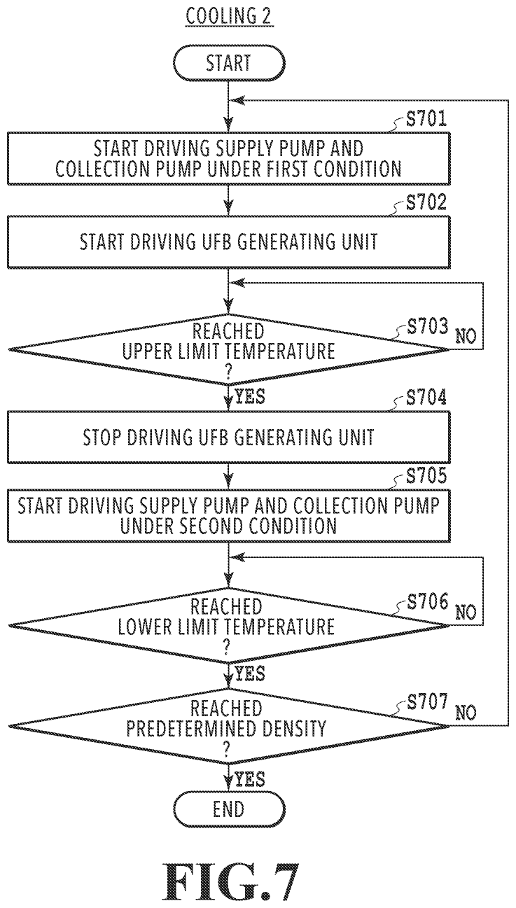

FIG. 7 is a flowchart illustrating the processes in the UFB generating step (S504) in the process of generating a UFB-containing liquid illustrated in FIG. 5 in the present embodiment.

Upon start of the UFB generating step, in S701, the CPU 2001 drives the supply pump 703 and the collection pump 704 under the first condition to circulate the liquid W through the circulation path B. Then, in S702, the CPU 2001 drives the UFB generating unit 1000. After that, in S703, the CPU 2001 determines whether the value of the temperature sensors 1107 has reached a preset upper limit value and, if not, repeats the UFB generation and the determination until the value reaches the upper limit value. If the value of the temperature sensors 1107 reaches the upper limit value, the CPU 2001 moves to S704 and stops driving the UFB generating unit 1000.

In S705, the CPU 2001 switches the supply pump 703 and the collection pump 704 from the first condition to the second condition and drives them in the second condition. As a result, the UFB generating unit 1000 is cooled. After that, in S706, the CPU 2001 determines whether the value of the temperature sensors 1107 has reached a preset lower limit value and, if not, repeats the determination until the value reaches the lower limit value. At this time, the UFB generating unit 1000 is not driven. If the value of the temperature sensors 1107 reaches the lower limit value, the CPU 2001 moves to S707 and determines whether the density of UFBs in the UFB-containing liquid inside the storing chamber 900 has reached a predetermined density based on the detection value of the UFB density sensor 906. The CPU 2001 returns S701 and repeats the processes if the density has not reached the predetermined density. The CPU 2001 terminates the process if the density has reached the predetermined density.

While the driving can be switched as soon as the temperature sensors 1107 output a value exceeding the upper limit or falling below the lower limit, the driving can be switched after confirming that the temperature sensors 1107 has output a value exceeding the upper limit or falling below the lower limit for a certain time (e.g., about 0.5 second) taking into account the effect of noise.

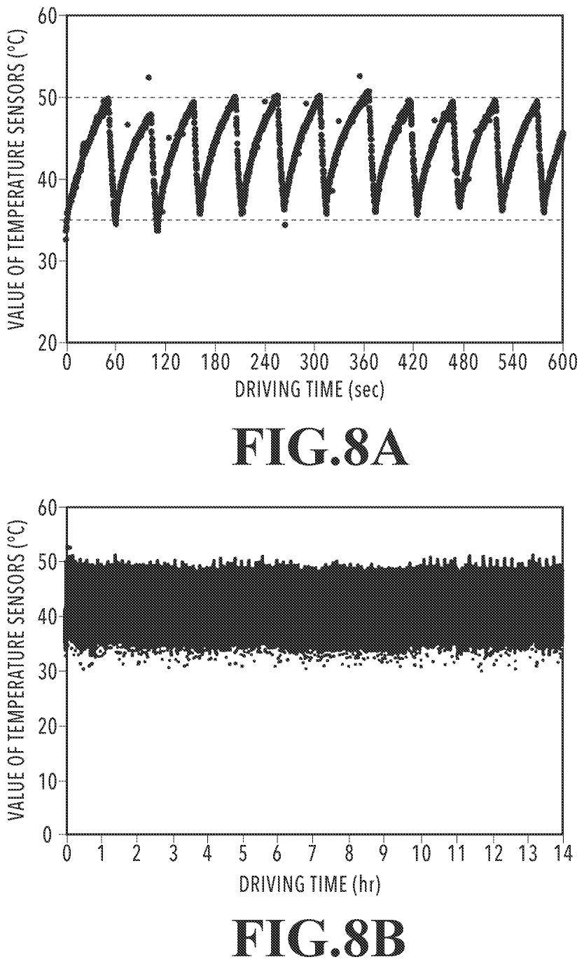

FIGS. 8A and 8B are graphs illustrating temperature rise profiles obtained by actually measuring the temperature of the UFB generating unit 1000 based on the temperature detected by the temperature sensors 1107 with the upper limit temperature set at 50° C. and the lower limit temperature set at 35° C. as an example of the second embodiment. FIG. 8A illustrates a temperature profile at short time intervals, and FIG. 8B illustrates a temperature profile at long time intervals. The temperature sensors 1107, which are attached to the heating element substrate 1100, actually measure the temperature of the heating element substrate 1100, but the temperature will be described in the following as the temperature of the UFB generating unit 1000 including the heating element substrate 1100.

As illustrated in FIG. 8A, it can be seen that the temperature of the UFB generating unit 1000 is held within a range of approximately 35 to 50° C. while defining a pectinate profile, and is controlled to be within a desired temperature range even after being continuously driven for more than 10 hours.

In the present embodiment, the driving of the supply pump 703, the collection pump 704, and the UFB generating unit 1000 is controlled based on the value of the temperature sensors. For this reason, a table in which driving frequencies and driving times are associated with each other does not need to be stored in the ROM in advance as described in the first embodiment, and UFBs can be generated freely under a desired condition.

Incidentally, in a case of driving the heating elements 1102 for a long time, the temperature rise characteristics can change over time. However, with the method in which the driving is controlled according to the value of the temperature sensors 1107 as in the present embodiment, not according to the driving time of the heating elements, it is possible to accurately maintain the temperature of the UFB generating unit 1000 within a predetermined range without being affected by the temporal changes.

For the UFB generating unit 1000, on which multiple heating element substrates 1100 are mounted as illustrated in FIG. 2, the values of multiple sets of temperature sensors 1107 are read. In this case, the driving can be controlled based on an average value of the values of the sets of sensors. Alternatively, the highest value among the values of the multiple sets of sensors can be employed as the set upper limit temperature, and the lowest value among the values of the multiple sets of sensors can be employed as the set lower limit temperature.

A third embodiment of the present disclosure will be described below with reference to drawings. Note that the basic configuration in the present embodiment is similar to that in the first embodiment, and the characteristic configuration will therefore be described below. In the present embodiment, a process of removing bubbles generated inside and/or having entered the UFB generating unit 1000 is performed as a process in the UFB generating step.

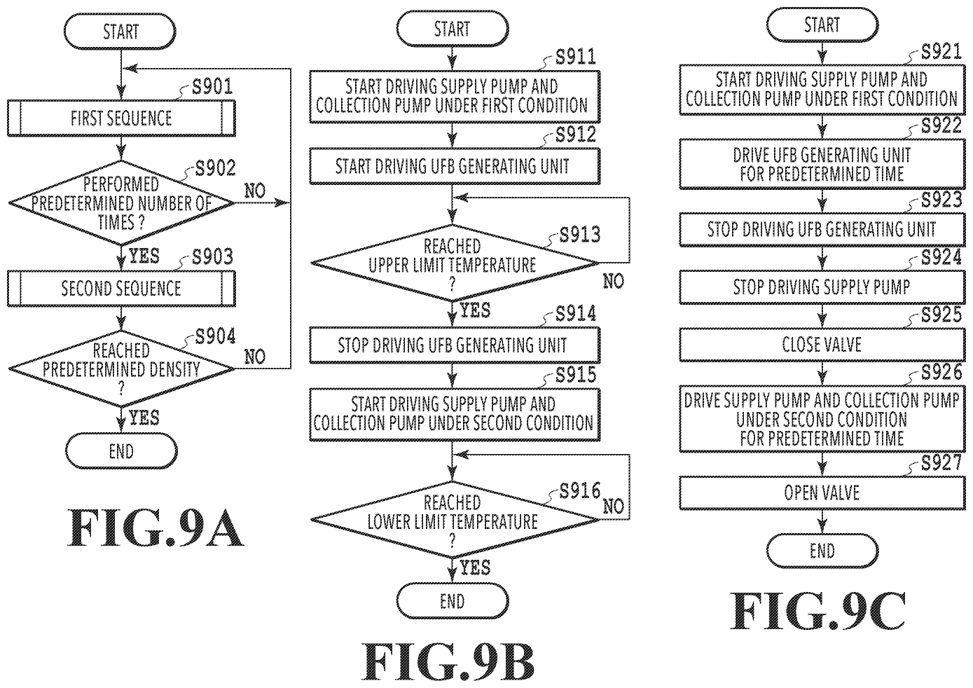

FIG. 9A is a flowchart illustrating the UFB generating step in the present embodiment. FIG. 9B is a flowchart illustrating processes in S901 in FIG. 9A. FIG. 9C is a flowchart illustrating processes in S903 in FIG. 9A. The UFB generating step in the present embodiment will be described below using the flowcharts of FIGS. 9A to 9C.

First, the flowchart of FIG. 9A will be described. Upon start of the UFB generating step, the CPU 2001 performs a first sequence in S901. Details of the first sequence will be described below. Then, in S902, the CPU 2001 determines whether the first sequence has been performed a predetermined number of times. If the first sequence has not been performed the predetermined number of times, the CPU 2001 returns to S901 and repeats the first sequence. If the first sequence has been performed the predetermined number of times, the CPU 2001 moves to S903 and performs a second sequence. Details of the second sequence will be described below. Thereafter, in S904, the CPU 2001 determines whether the density of UFBs in the UFB-containing liquid inside the storing chamber 900 has reached a predetermined density based on the detection value of the UFB density sensor 906. The CPU 2001 returns S901 and repeats the processes if the density has not reached the predetermined density. The CPU 2001 terminates the process if the density has reached the predetermined density.

The first sequence in S901 in FIG. 9A will be described using the flowchart of FIG. 9B. Upon start of the UFB generating step, in S911, the CPU 2001 drives the supply pump 703 and the collection pump 704 under the first condition to circulate the liquid W through the circulation path B. Then, in S912, the CPU 2001 drives the UFB generating unit 1000. After that, in S913, the CPU 2001 determines whether the value of the temperature sensors 1107 has reached a preset upper limit value and, if not, repeats the UFB generation and the determination until the value reaches the upper limit value. If the value of the temperature sensors 1107 reaches the upper limit value, the CPU 2001 moves to S914 and stops driving the UFB generating unit 1000.

In S915, the CPU 2001 switches the supply pump 703 and the collection pump 704 from the first condition to the second condition and drives them in the second condition. As a result, the UFB generating unit 1000 is cooled. After that, in S916, the CPU 2001 determines whether the value of the temperature sensors 1107 has reached a preset lower limit value and, if not, repeats the determination until the value reaches the lower limit value. At this time, the UFB generating unit 1000 is not driven. If the value of the temperature sensors 1107 reaches the lower limit value, the CPU 2001 terminates the process.

The second sequence in S903 in FIG. 9A will be described using the flowchart of FIG. 9C.

Upon start of the second sequence, the CPU 2001 drives the supply pump 703 and the collection pump 704 under the first condition to circulate the liquid in S921. Then, in S922, the CPU 2001 drives the UFB generating unit 1000 for a predetermined time. After that, the CPU 2001 stops driving the UFB generating unit 1000 in S923 and stops driving the supply pump 703 in S924. Then, the CPU 2001 closes the valve 1003 in S925. Next, in S926, the CPU 2001 switches the collection pump 704 to the second condition and drives it under the second condition for a predetermined time with the valve 1003 closed to thereby suck out all of the liquid W inside the UFB generating unit 1000 (third mode). In this way, bubbles generated inside and/or having entered the UFB generating unit 1000 are removed. Thereafter, in S927, the CPU 2001 opens the valve 1003. Opening the valve 1003 fills the inside of the UFB generating unit 1000 with the liquid W.

It is possible to remove the bubbles even in a case where the second condition in S926 in the present embodiment is the same as the first condition. However, the flow velocity under the second condition in S926 is desirably set to be higher than that under the first condition so that the liquid W inside the UFB generating unit 1000 can be sucked out in a shorter time. This minimizes the time for which the UFB generation is stopped, and thus enables efficient UFB generation.

As described above, not only the temperature of the UFB generating unit 1000 is maintained within a predetermined range, but also bubbles are removed. This prevents the bubbles from obstructing the bubble generation and enables more stable production of a UFB-containing liquid.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-212045 filed Dec. 28, 2022, which is hereby incorporated by reference wherein in its entirety.

What is claimed is:

1. An ultrafine bubble-containing liquid producing apparatus comprising:
an ultrafine bubble generating unit configured to generate ultrafine bubbles inside a liquid;
a circulating unit configured to circulate the liquid through a circulation path including the ultrafine bubble generating unit; and
a control unit configured to control the ultrafine bubble generating unit and the circulating unit,
wherein the control unit, based on a predetermined condition, switches between a first mode where the liquid in the circulation path is circulated at a first flow velocity and a second mode where the liquid in the circulation path is circulated at a second flow velocity higher than the first flow velocity.

2. The ultrafine bubble-containing liquid producing apparatus according to claim 1, wherein the predetermined condition is a time for which the ultrafine bubble generating unit is driven.

3. The ultrafine bubble-containing liquid producing apparatus according to claim 1, further comprising a temperature detecting unit that detects temperature of the ultrafine bubble generating unit, wherein the predetermined condition is the detected temperature.

4. The ultrafine bubble-containing liquid producing apparatus according to claim 3, wherein the control unit switches to the second mode from the first mode in a case where the detected temperature reaches a predetermined upper limit temperature.

5. The ultrafine bubble-containing liquid producing apparatus according to claim 3, wherein the ultrafine bubble generating unit includes a plurality of the temperature detecting units, and
the control unit switches to the second mode from the first mode in a case where an average value of the detected temperatures reaches a predetermined upper limit temperature.

6. The ultrafine bubble-containing liquid producing apparatus according to claim 3, wherein
the ultrafine bubble generating unit includes a plurality of the temperature detecting units, and
the control unit switches to the second mode from the first mode in a case where a highest temperature from among the detected temperatures reaches a predetermined upper limit temperature.

7. The ultrafine bubble-containing liquid producing apparatus according to claim 3, wherein the control unit terminates an operation in the second mode in a case where the detected temperature reaches a predetermined lower limit temperature.

8. The ultrafine bubble-containing liquid producing apparatus according to claim 3, wherein
the ultrafine bubble generating unit includes a plurality of the temperature detecting units, and
the control unit executes an operation in the second mode in a case where an average value of the detected temperatures reaches a predetermined lower limit temperature.

9. The ultrafine bubble-containing liquid producing apparatus according to claim 3, wherein
the ultrafine bubble generating unit includes a plurality of the temperature detecting units, and
the control unit executes an operation in the second mode in a case where a lowest temperature from among the detected temperatures reaches a predetermined lower limit temperature.

10. The ultrafine bubble-containing liquid producing apparatus according to claim 1,
wherein the circulating unit includes:
a circulation unit that is disposed downstream of the ultrafine bubble generating unit in the circulation path and is configured to circulate the liquid in the circulation path, and
a closing unit that is disposed upstream of the ultrafine bubble generating unit in the circulation path and is configured to switch between closing and opening the circulation path, and
the control unit executes a third mode where the control unit drives the circulation unit while driving of the ultrafine bubble generating unit is stopped and the closing unit is closed.

11. The ultrafine bubble-containing liquid producing apparatus according to claim 1, further comprising a storing unit disposed at an intermediate portion of the circulation path that is configured to store the liquid.

12. The ultrafine bubble-containing liquid producing apparatus according to claim 11, further comprising an agitating unit configured to agitate the stored liquid.

13. The ultrafine bubble-containing liquid producing apparatus according to claim 11, further comprising a density detecting unit configured to detect density of ultrafine bubbles in the stored liquid.

14. The ultrafine bubble-containing liquid producing apparatus according to claim 11, further comprising a temperature control unit configured to control temperature of the stored liquid.

15. The ultrafine bubble-containing liquid producing apparatus according to claim 1, wherein the ultrafine bubble generating unit generates ultrafine bubbles by film boiling caused at an interface between the liquid and a heating element by causing the heating element to generate heat.

16. The ultrafine bubble-containing liquid producing apparatus according to claim 1, further comprising a dissolving unit configured to dissolve a predetermined gas into the liquid to be circulated through the circulation path.

17. A method for producing an ultrafine bubble-containing liquid, the method comprising:
generating ultrafine bubbles inside a liquid;
circulating the liquid through a circulation path; and
switching, based on a predetermined condition, between a first mode where the liquid in the circulation path is circulated at a first flow velocity and a second mode where the liquid in the circulation path is circulated at a second flow velocity higher than the first flow velocity.
